(19) United States
(12) Patent Application Publication
(10) Pub. No.: US 2014/0002658 A1
(43) Pub. Date: Jan. 2, 2014

(54) OVERTAKING VEHICLE WARNING SYSTEM AND OVERTAKING VEHICLE WARNING METHOD

(71) Applicant: LG INNOTEK CO., LTD., SEOUL (KR)

(72) Inventors: Jun Chul KIM, Seoul (KR); Ki Dae KIM, Seoul (KR); Adhipathi REDDY, Seoul (KR)

(21) Appl. No.: 13/932,217

(22) Filed: Jul. 1, 2013

(30) Foreign Application Priority Data
Jun. 29, 2012 (KR) 10-2012-0071228

(51) Int. Cl. B60Q 9/00

(52) U.S. Cl. CPC B60Q 9/008
USPC 348/148

(57) ABSTRACT

An overtaking vehicle warning system includes an image photographing unit attached to a front of a vehicle to photograph an object in a forward direction of the vehicle; a driving unit receiving image data from the image photographing unit to select a region of interest, extracting a feature of a vertical edge from the region of interest to compare the feature of the vertical edge with a feature of a previous frame, and generating warning generating signal when a matched feature is equal to or greater than a threshold value; and a warning unit receiving the warning generating signal to generate an overtaking vehicle warning signal. An edge region is searched from an image photographed in the forward direction to obtain a predetermined feature, and warning is generated with respect to the overtaking vehicle by tracking a vehicle having the corresponding feature.

### CROSS-REFERENCE TO RELATED APPLICATION

This application claims the benefit under 35 U.S.C. §119 of Korean Patent Application No. 10-2012-0071228, filed Jun. 29, 2012, which is hereby incorporated by reference in its entirety.

### BACKGROUND

The embodiment relates to an overtaking vehicle warning system and an overtaking vehicle warning method.

In general, traffic accident preventing technologies are mainly focused on vehicle collision preventing technologies.

A technology dedicated for a single vehicle predicts collision between vehicles using information sensed from various sensors.

Further, a technology based on cooperation between vehicles senses collision between the vehicles by collecting various information from peripheral vehicles or an infrastructure system using a communication technology such as dedicated short-range communications (DRSC).

However, the traffic accident preventing technology according to the related art predicts traffic accident using locations, speed, and direction information of vehicles in cooperation with a vehicle system or receives traffic information from peripheral vehicles or an infrastructure system using a communication technology.

Accordingly, an interworking system is required between a warning system and a vehicle, and data may be polluted due to an erroneous operation of some system.

### BRIEF SUMMARY

The embodiment provides a warning system capable of preventing accident by warning an unexpected overtaking vehicle in a single system without cooperation with a vehicle system.

According to the embodiment, there is provided an overtaking vehicle warning system including: an image photographing unit attached to a front of a vehicle to photograph an object in a forward direction of the vehicle; a driving unit receiving image data from the image photographing unit to select a region of interest, extracting a feature of a vertical edge from the region of interest to compare the feature of the vertical edge with a feature of a previous frame, and generating warning generating signal when a matched feature is equal to or greater than a threshold value; and a warning unit receiving the warning generating signal to generate an overtaking vehicle warning signal.

The driving unit may include: a pre-processing unit selecting the region of interest of the image data, detecting the vertical edge from the region of interest, and extracting a feature of the vertical edge; a feature tracking unit tracking a feature of a candidate vehicle by matching the extracted feature of the vertical edge with the feature of the previous frame; and a warning generating unit counting a number of lane features matching with features of candidate vehicles in a plurality of previous frames among the feature of the candidate vehicle, and generating the warning generating signal when the counted number of lane features is equal to or greater than the threshold value.

The driving unit may further include a post-processing unit counting the number of lane features matching with features of candidate vehicles in a plurality of previous frames among the feature of the candidate vehicle, and verifying whether the feature of the candidate vehicle corresponds to an overtaking vehicle when the counted number of lane features is equal to or greater than the threshold value.

The post processing unit may determine whether the feature of the candidate vehicle is detected in a neighbor region of interest next to the region of interest.

The region of interest may be defined as a left side region and a right side region of the image.

The region of interest may be increased as a time elapses.

The neighbor region of interest may have an area equal to an area of the region of interest.

The feature tracking unit may calculate an edge location of a current frame in a vehicle running direction based on the feature of the previous frame to acquire the feature of the candidate vehicle.

The pre-processing unit may search the vertical edge using a Sobel operator and a non-maximal suppression algorithm.

According to the embodiment, there is provided an overtaking vehicle warning method including: generating image data by photographing an object in a forward direction of a vehicle; receiving the image data to select a region of interest, and extracting a feature of an vertical edge from the region of interest; tracking features of candidate vehicles in a current frame by comparing the feature of the vertical edge with a feature of a previous frame; and counting the number of features of the candidate vehicles in a plurality of previous frames having a direction equal to a running direction of the vehicle, and generating a warning generating signal when the number of features of the candidate vehicles is equal to or greater than a threshold value.

The selecting of the region of interest may include selecting a left side region and a right side region of the image as the region of interest.

The overtaking vehicle warning method may further include determining whether the feature of the candidate vehicle is detected in a neighbor region of interest next to the region of interest when the number of features of the candidate vehicles is equal to or greater than the threshold value.

The neighbor region of interest may have an area equal to an area of the region of interest.

The tracking of the features of candidate vehicles may include calculating an edge location of a current frame in a vehicle running direction based on the feature of the previous frame to acquire the feature of the candidate vehicle.

A Sobel operator and a non-maximal suppression algorithm may be used to search the vertical edge.

According to the embodiment, an edge region is searched from an image photographed in the forward direction to obtain a predetermined feature, and warning is generated with respect to the overtaking vehicle by tracking a vehicle having the corresponding feature.

That is, a region of interest (ROI) is extracted from the image to determine and verify whether there is an overtaking vehicle, so that the reliability can be improved and the overtaking vehicle warning system is operated as a single system so that the vehicle can be detected regardless of external environment.

### BRIEF DESCRIPTION OF THE DRAWINGS

FIG. 1 is a block diagram showing a configuration of an overtaking vehicle warning system according to the embodiment;

FIG. 2 is a flowchart illustrating an operation of the overtaking vehicle warning system shown in FIG. 1;

FIG. 3 is a flowchart illustrating an image pre-processing step of FIG. 2 in detail;

FIGS. 4A and 4B are photographs illustrating an image acquired by pre-processing of FIG. 3; and

FIG. 5 is a photograph illustrating an image acquired after post-processing of FIGS. 4A and 4B.

### DETAILED DESCRIPTION

Hereinafter, the embodiments will be described with reference to accompanying drawings in detail so that those skilled in the art to which the invention pertains can easily realize the embodiments. However, the embodiments may have various modifications without limitation.

In the following description, when a unit is referred to as it includes a component, the unit may not exclude other components, but further include another component unless the context indicates otherwise.

The embodiment provides a system attached to a vehicle to warn a sudden overtaking vehicle while the vehicle is running

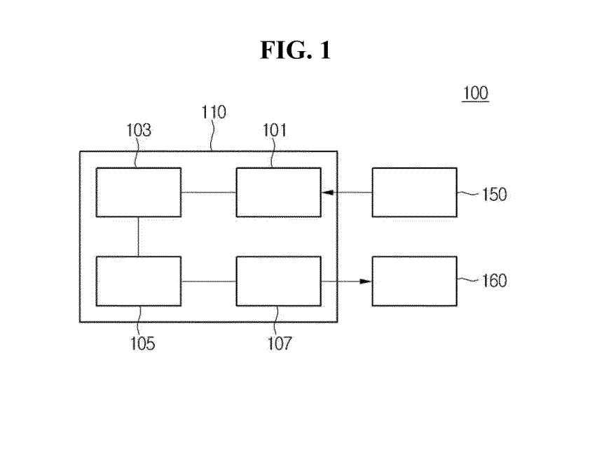

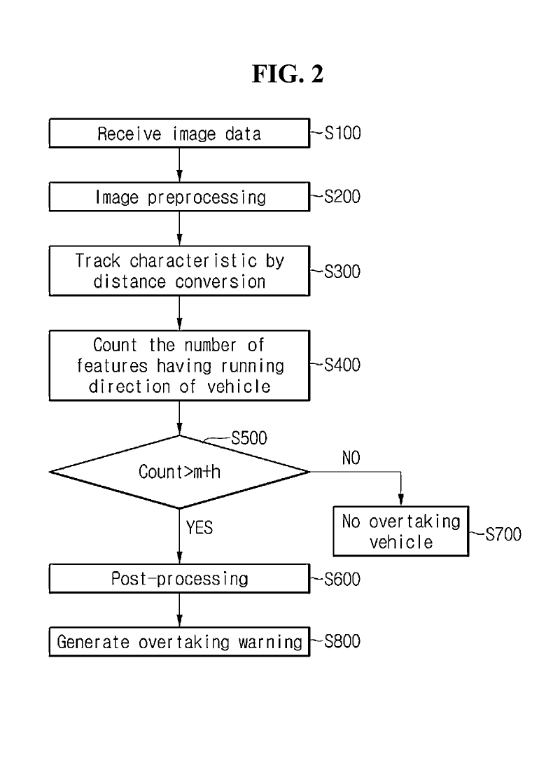

Hereinafter, an overtaking vehicle warning system according to the embodiment will be described with reference to FIGS. 1 and 2.

FIG. 1 is a block diagram showing a configuration of an overtaking vehicle warning system according to the embodiment, and FIG. 2 is a flowchart illustrating an operation of the overtaking vehicle warning system shown in FIG. 1.

Referring to FIG. 1, the overtaking vehicle warning system includes an image photographing unit 150, a warning unit 160, and a driving unit 110.

The image photographing unit 150 includes a camera photographing a subject at a predetermined frequency, in which the camera photographs a front of a vehicle and transfers a photographed image to the driving unit 110.

In this case, the image photographing unit 150 may include an infrared camera which may operate at night, and may be operated by controlling a lighting system according to external environment.

The warning unit 160 receives a warning generating signal from the driving unit 110 and provides an overtaking vehicle warning signal to a driver.

In this case, the overtaking vehicle warning signal may include an audible signal such as alarm. In addition, the overtaking vehicle warning signal may include a visible signal displayed in a navigation device of the vehicle.

The driving unit 110 receives image data photographed from the image photographing unit 150 in a unit of frame (S100), extracts a vertical edge from the received image data to select a feature, counts vehicles having the corresponding feature in a plurality of frames and generates the warning generating signal if a counting value is equal to or greater than a threshold value.

As illustrated in FIG. 1, the driving unit 110 may include a pre-processing unit 101, a feature tracking unit 103, a post-processing unit 105, and a warning generating unit 107.

The pre-processing unit 101 receives image data from the image photographing unit 150 (S100), selects a region of interest (ROI) from the image data to extract a vertical edge from the ROI, and selects a feature of the vertical edge (S200).

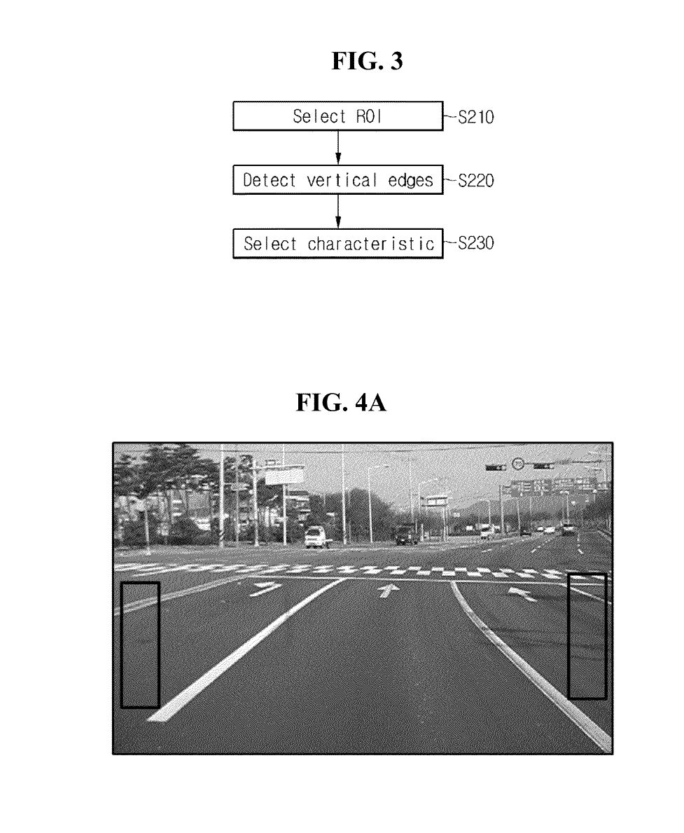

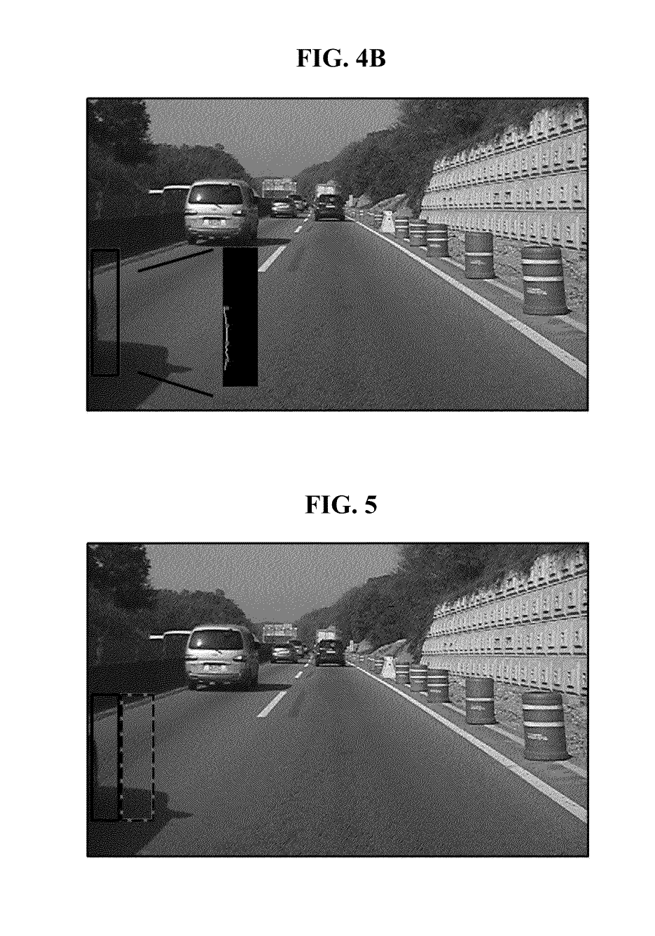

In detail, as illustrated in FIG. 3, the pre-processing unit 101 selects the ROI from one frame image as shown in FIG. 4A (S210).

The ROI is defined as a left side and a right side of the vehicle based on a lane boundary of the vehicle.

The ROI may be formed over a lane as illustrated in a black box of FIG. 4A, and may be selected as a lower portion of the image. The size of the ROI may be variously changed, and may be gradually increased from a small ROI as frames are increased.

Next, an overtaking vehicle in the ROI is observed to detect the vertical edges (S220).

The vertical edges are used as a feature vector, and the vertical edge protruding after the vehicle enters the ROI is observed.

Detected vertical edges have information of the overtaking vehicle, and the edge vector may be used as a feature of a candidate vehicle in lieu of a feature point. This is because the feature point sensitively varies according to a noise and a situation in real-time so that unreliable running algorithm may be caused.

The vertical edge may be detected using a Sobel operator and a non-maximal suppression algorithm.

In FIG. 4B, the vertical edges detected from a left ROI are marked with a white line, and a feature vector is marked with dots.

After that, the pre-processing unit 101 selects the edge vector as a feature of a candidate vehicle to track a feature (S230). That is, in order to reduce a calculating time for tracking, several representative edge vectors are selected from the vertical edges.

In this case, the selected ROI is divided into a plurality of blocks, the number of edges included in each block is counted and the block including edges having a threshold value or more is selected as the feature. A vector located at the selected block is defined as the feature of the candidate vehicle in a current frame.

In this manner, if the feature of the candidate vehicle in each frame is defined, an operation of the feature tracking unit 103 starts (S300).

That is, the feature tracking unit 103 tracks the feature of the candidate vehicle in a previous frame to perform distance conversion. First, a feature search region is selected based on block location information in the current frame.

If the feature search region is selected, a search region distance conversion is performed, and the edge vector is used to find a minimum distance location. The minimum distance location indicates an edge location according to the running direction of a vehicle in the current frame. If running information is obtained, a new feature is generated from the current frame, and the above feature tracking is performed in the subsequent frames.

If the feature tracking is terminated as described above, the warning generating unit 107 tracks features of candidate vehicles in a plurality of frames to count the number of features of the candidate vehicles having the running direction the same as the moving direction of the vehicle (S400).

If the number of the features of the candidate vehicles is smaller than a threshold value (S500), the warning generating unit 107 determines that there is no overtaking vehicle (S700). If the number of the features of the candidate vehicles is greater than the threshold value, the warning generating unit 107 determines that there is an overtaking vehicle.

In this case, when it is determined that there is the overtaking vehicle, the post-processing unit 105 performs post-processing to verify the overtaking vehicle (S600).

As illustrated in FIG. 5, a neighbor ROI having the same area as that of the ROI is selected to select the features of the candidate vehicles based on the running direction from among the features. The neighbor ROI may be selected using location information of the feature. A vertical start point of the neighbor ROI may be calculated using a location of a feature having the running direction similar to the moving direction of the vehicle.

If the neighbor ROI is determined, an edge is acquired according to direction information of the ROI and the neighbor ROI. Next, edge direction histograms of two regions are acquired, and a distance between the two edge direction histograms is calculated using a histogram intersection scheme.

After that, it is examined whether the overtaking vehicle found in the ROI is also found in the neighbor ROI. If the feature similar to that of the ROI is not found in the neighbor ROI, the warning generating unit 107 determines that there is the overtaking vehicle and outputs an overtaking warning generating signal (S800).

In this manner, if the driving unit 110 generates an overtaking warning generating signal and transmits the overtaking warning generating signal to the warning unit 160, the warning unit 160 audibly or visibly provides warning to the driver.

Although a preferred embodiment of the disclosure has been described for illustrative purposes, those skilled in the art will appreciate that various modifications, additions and substitutions are possible, without departing from the scope and spirit of the invention as disclosed in the accompanying claims.

What is claimed is:

1. An overtaking vehicle warning system comprising:
an image photographing unit attached to a front of a vehicle to photograph an object in a forward direction of the vehicle;
a driving unit receiving image data from the image photographing unit to select a region of interest, extracting a feature of a vertical edge from the region of interest to compare the feature of the vertical edge with a feature of a previous frame, and generating warning generating signal when a matched feature is equal to or greater than a threshold value; and
a warning unit receiving the warning generating signal to generate an overtaking vehicle warning signal.

2. The overtaking vehicle warning system of claim 1, wherein the driving unit comprises:
a pre-processing unit selecting the region of interest of the image data, detecting the vertical edge from the region of interest, and extracting a feature of the vertical edge;
a feature tracking unit tracking a feature of a candidate vehicle by matching the extracted feature of the vertical edge with the feature of the previous frame; and
a warning generating unit counting a number of lane features matching with features of candidate vehicles in a plurality of previous frames among the feature of the candidate vehicle, and generating the warning generating signal when the counted number of lane features is equal to or greater than the threshold value.

3. The overtaking vehicle warning system of claim 2, wherein the driving unit further comprises a post-processing unit counting the number of lane features matching with features of candidate vehicles in a plurality of previous frames among the feature of the candidate vehicle, and verifying whether the feature of the candidate vehicle corresponds to an overtaking vehicle when the counted number of lane features is equal to or greater than the threshold value.

4. The overtaking vehicle warning system of claim 3, wherein the post processing unit determines whether the feature of the candidate vehicle is detected in a neighbor region of interest next to the region of interest.

5. The overtaking vehicle warning system of claim 4, wherein the region of interest is defined as a left side region and a right side region of the image.

6. The overtaking vehicle warning system of claim 5, wherein the region of interest is increased as a time elapses.

7. The overtaking vehicle warning system of claim 6, wherein the neighbor region of interest has an area equal to an area of the region of interest.

8. The overtaking vehicle warning system of claim 7, wherein the feature tracking unit calculates an edge location of a current frame in a vehicle running direction based on the feature of the previous frame to acquire the feature of the candidate vehicle.

9. The overtaking vehicle warning system of claim 2, wherein the pre-processing unit searches the vertical edge using a Sobel operator and a non-maximal suppression algorithm.

10. An overtaking vehicle warning method comprising:
generating image data by photographing an object in a forward direction of a vehicle;
receiving the image data to select a region of interest, and extracting a feature of an vertical edge from the region of interest;
tracking features of candidate vehicles in a current frame by comparing the feature of the vertical edge with a feature of a previous frame; and
counting the number of features of the candidate vehicles in a plurality of previous frames having a direction equal to a running direction of the vehicle, and generating a warning generating signal when the number of features of the candidate vehicles is equal to or greater than a threshold value.

11. The overtaking vehicle warning method of claim 10, wherein the selecting of the region of interest comprises selecting a left side region and a right side region of the image as the region of interest.

12. The overtaking vehicle warning method of claim 10, further comprising determining whether the feature of the candidate vehicle is detected in a neighbor region of interest next to the region of interest when the number of features of the candidate vehicles is equal to or greater than the threshold value.

13. The overtaking vehicle warning method of claim 12, wherein the neighbor region of interest has an area equal to an area of the region of interest.

14. The overtaking vehicle warning method of claim 10, wherein the tracking of the features of candidate vehicles comprises calculating an edge location of a current frame in a vehicle running direction based on the feature of the previous frame to acquire the feature of the candidate vehicle.

15. The overtaking vehicle warning method of claim 14, wherein a Sobel operator and a non-maximal suppression algorithm are used to search the vertical edge.
